(19) United States
(12) Patent Application Publication
(10) Pub. No.: US 2022/0410114 A1
(43) Pub. Date: Dec. 29, 2022

(54) DEVICE AND METHOD OF PRODUCING LIQUID SILICON

(71) Applicant: Schmid Silicon Technology GmbH, Freudenstadt (DE)

(72) Inventors: Peter Feinäugle, Freudenstadt (DE); Jochem Hahn, Rottenburg am Neckar (DE); Georgij Petrik, Böblingen (DE); Christian Schmid, Freudenstadt (DE)

(21) Appl. No.: 17/624,060

(22) PCT Filed: Jul. 2, 2020
(86) PCT No.: PCT/EP2020/068743

§ 371 Date: Dec. 30, 2021

(30) Foreign Application Priority Data
Jul. 4, 2019 (DE) 10 2019 209 898.3

(51) Int. Cl. B01J 19/08; B01J 4/00; C01B 33/021

(52) U.S. Cl. CPC B01J 19/08; B01J 4/002; C01B 33/021; B01J 2204/002; B01J 2219/0898; H05H 1/48

(57) ABSTRACT

An apparatus that forms liquid silicon includes a. a device by which a gas can be brought to a high-temperature state in which it is at least partially present as plasma, b. a reaction space and a feed conduit for the high-temperature gas opening into the reaction space, c. a nozzle having a nozzle channel that opens directly into the reaction space and through which a gaseous or particulate silicon-containing starting material can be fed into the reaction space, and d. a device adapted to introduce an inert gas into the reaction space such that it protects the exit opening of the nozzle channel against thermal stress resulting from the high-temperature gas.

### TECHNICAL FIELD

This disclosure relates to an apparatus and a process for forming liquid silicon.

### BACKGROUND

High-purity silicon is generally produced in a multistage process starting out from metallurgical silicon, which generally has a relatively high proportion of impurities. To purify the metallurgical silicon, it can, for example, be converted into a trihalosilane such as trichlorosilane (SiHCl₃) which is subsequently thermally decomposed to produce high-purity silicon. Such a procedure is known, for example, in DE 29 19 086 A1. As an alternative, high-purity silicon can also be obtained by thermal decomposition of monosilane (SiH₄) as is described, for example, in DE 33 11 650 A1.

In recent years, obtaining high-purity silicon by thermal decomposition of monosilane has moved ever more into the foreground. Thus, for example, DE 10 2011 089 695 A1, DE 10 2009 003 368 B3 and DE 10 2015 209 008 A1 describe apparatuses into which monosilane can be injected and in which silicon rods heated to a high temperature, on which the monosilane is decomposed, are arranged. The silicon formed is deposited in solid form on the surface of the silicon rods.

An alternative approach is followed in DE 10 2008 059 408 A1. Injection of monosilane into a reaction space into which a gas stream that has been heated to a high temperature is also introduced is described there. On contact with the gas stream, the monosilane is decomposed into its elemental constituents. The silicon vapor formed can be condensed. The condensation forms small droplets of liquid silicon. The droplets are collected and liquid silicon obtained can be processed further directly, i.e., without intermediate cooling, for example, converted into a silicon single crystal in a float-zone process or a Czochralski process.

However, an ongoing problem associated with the procedure proposed in DE 10 2008 059 408 A1 is that a significant part of the silicon formed by the decomposition is not obtained in the desired droplet form but instead as silicon dust. Furthermore, it is frequently observed that the nozzle openings via which the monosilane is injected into the reaction space becomes blocked as a result of deposition of solid Si.

Injection of monosilane or silicon particles directly into a plasma flame is known from WO 2018/157256 A1 and U.S. Pat. No. 7,615,097 B2. The silicon vapor formed is quenched to form silicon particles. However, injection of the starting materials mentioned directly into a plasma flame is, according to our experience, not suitable for the industrial production of silicon. It is extremely difficult to keep the plasma flame stable when injecting large amounts of the abovementioned starting materials since the monosilane or the silicon particles and in particular silicon droplets which have already been formed interfere with generation of the plasma.

It could therefore be helpful to provide a technical method of forming liquid silicon while avoiding or at least reducing the abovementioned problems.

### SUMMARY

We provide an apparatus that forms liquid silicon including a. a device by which a gas can be brought to a high-temperature state in which it is at least partially present as plasma, b. a reaction space and a feed conduit for the high-temperature gas opening into the reaction space, c. a nozzle having a nozzle channel that opens directly into the reaction space and through which a gaseous or particulate silicon-containing starting material can be fed into the reaction space, and d. a device adapted to introduce an inert gas into the reaction space such hat it protects the exit opening of the nozzle channel against thermal stress resulting from the high-temperature gas.

We also provide a process of forming liquid silicon, including a. brining a gas into a high-temperature state in which it is at least partially present as plasma, b. introducing the high-temperature gas into the reaction space, c. feeding a gaseous or particulate silicon-containing starting material into the reaction space via a nozzle having a nozzle channel that opens directly into the reaction space, and d. introducing an inert gas into the reaction space so that it protects the exit opening of the nozzle channel against thermal stress arising from the high-temperature gas.

### BRIEF DESCRIPTION OF THE DRAWINGS

FIG. 1 schematically shows a multifluid nozzle that feeds in a silicon-containing starting material (longitudinal section).

FIG. 2 schematically shows a reaction space in which the silicon-containing starting material can be contacted with a plasma (partly cut depiction).

FIG. 3 schematically shows a plurality of condensation chambers for condensation of silicon (partly cut depiction).

FIG. 4 schematically shows a preferred example of our apparatus (partly cut depiction).

FIG. 5 schematically shows a preferred example of our apparatus (partly cut depiction).

### DETAILED DESCRIPTION

Our apparatus produces liquid silicon. It always comprises:

a. a device by which a gas can be brought to a high-temperature state in which it is at least partially present as plasma,
b. a reaction space and a feed conduit for the high-temperature gas opening into the reaction space,
c. a nozzle having a nozzle channel that opens directly into the reaction space and through which a gaseous or particulate silicon-containing starting material can be fed into the reaction space, and also
d. a device that makes it possible to introduce an inert gas into the reaction space such that it protects the exit opening of the nozzle channel against thermal stress resulting from the high-temperature gas.

The apparatus and process are suitable both for forming high-purity semiconductor silicon suitable for semiconductor applications and forming less pure solarsilicon that is suitable for producing solar modules.

The basic principles of producing the liquid silicon are based on DE 10 2008 059 408 A1: the high-temperature gas is brought into contact with the silicon-containing starting material with the gas having to have a sufficiently high temperature either to decompose, melt or vaporize the starting material, depending on its nature, when the gas comes into contact with the starting material. The silicon vapor formed can be condensed in a subsequent step.

Preference is given for heating the gas, in particular plasma formation, not occurring within the reaction space. Rather, plasma formation and contacting of the high-temperature gas with the silicon-containing starting material are, as previously described in DE 10 2008 059 408 A1, preferably separated spatially from one another.

The device for producing the high-temperature gas is preferably a plasma generation device. This can be selected as a function of the desired purity of the silicon to be formed. Thus, for example, devices for producing inductively coupled plasmas are particularly suitable for the production of high-purity silicon while the production of silicon of lower purity can also be carried out using DC plasma generators. In the latter, an electric arc formed between electrodes provides the energy input into the gas to convert it into the high-temperature state.

DC plasma generators can have an extremely simple structure. In the simplest form, they can comprise the electrodes that produce the electric arc and a suitable voltage supply, with the electrodes being arranged in a space or passage through which the gas to be heated flows.

The abovementioned spatial separation of the heating and the contacting of the high-temperature gas with the silicon-containing starting material means, when using a DC plasma generator, specifically that the silicon-containing starting material cannot contact the electric arc. For this purpose, the electrodes of the DC plasma generator are preferably arranged either in the feed conduit opening into the reaction space or the DC plasma generator is located upstream of this feed conduit. The gas particularly preferably first flows through the electric arc where it is heated or converted into a plasma and then, downstream of the electric arc, contacts the silicon-containing starting material. In this way, the heating of the gas or the generation of the plasma is uncoupled from introduction of the silicon-containing starting material and is not adversely affected by the introduction.

When using inductively coupled plasmas, contacting with the silicon-containing starting material preferably takes place, for the same reason, outside the effective region of the induction coil or induction coils used. The gas particularly preferably first flows through the induction coil or induction coils, where it is heated, and then, downstream of the induction coil or coils, comes into contact with the silicon-containing starting material.

Preferably, the high-temperature gas is, after having been heated, even cooled by targeted technical measures such as mixing the high-temperature gas with a moderating gas having a comparatively low temperature before it is contacted with the silicon-containing starting material. Depending on the silicon-containing starting material used, the temperatures of a plasma are not absolutely necessary for vaporization or decomposition of the starting material. The moderating gas can be mixed into the high-temperature gas via an appropriate feed point in the conduit provided for the high-temperature gas. The moderating gas can be, for example, hydrogen.

The spatial separation of the heating of the gas and the contacting of the gas with the silicon-containing starting material ensures that relatively large amounts of the silicon-containing starting material can also be reacted without this having an adverse effect on the stability of the plasma.

Particular preference is given to a hydrogen plasma being produced using the device for producing the high-temperature gas. Hydrogen is particularly advantageous as high-temperature gas when the silicon compound is monosilane. Monosilane decomposes into silicon and hydrogen on contact with the high-temperature gas. Thus, only two elements then have to be separated from one another.

Further preferably, a noble gas or a mixture of a noble gas and hydrogen can be used instead of hydrogen. For example, argon is suitable and can be added to the hydrogen in a proportion of, for example, 1% to 50%.

The gas is preferably heated to a temperature of 2000° C. to 10000° C., preferably 2000° C. to 6000° C., by the device for producing the high-temperature gas.

The silicon-containing starting material can also be selected as a function of the desired purity. To produce semiconductor silicon, gaseous silicon-containing starting materials such as the abovementioned monosilane or trichlorosilane are particularly suitable as silicon-containing starting material. Trichlorosilane has the disadvantage compared to monosilane that it forms chemically aggressive decomposition products on contact with the gas which has been brought into the high-temperature state. In contrast, only silicon and hydrogen are formed in the decomposition of monosilane.

To produce less pure silicon, particulate metallurgical silicon can also be used as starting material. This melts or vaporizes on contact with the high-temperature gas, in particular the plasma. For example, the particulate silicon can be fed into the reaction space with the aid of a carrier gas stream, for example, hydrogen.

Quartz in particulate form can also serve as particulate silicon-containing starting material. Quartz can be reduced to metallic silicon on contact with a hydrogen plasma.

In principle, particulate silicon alloys, e.g., particulate ferrosilicon, can also be used as particulate silicon-containing starting material. Silicon alloys are then formed therefrom.

Moreover, “particulate” means that the silicon-containing starting material is present in the form of particles having an average size of 10 nm to 100 μm. The particulate silicon-containing starting material is preferably free of particles having sizes of >100 μm.

If monosilane serves as silicon-containing starting material, the high-temperature gas with which it is contacted is preferably heated to a temperature of 1410° C. to 2500° C., particularly preferably 1600° C. to 1800° C., before contacting. This can, for example, occur by mixing in the abovementioned gas having the comparatively low temperature. On the other hand, when the abovementioned solid silicon-containing starting materials are used, relatively high temperatures are generally required. In these examples, the gas preferably has a temperature of >3000° C.

Nozzles having a nozzle channel and that open directly into the reaction space have already been installed in plasma reactors of the type described in DE 10 2008 059 408 A1. As stated at the outset, the exit openings become blocked very quickly during operation. Problems of this type have been able to be overcome surprisingly efficiently by the device that introduces the inert gas.

The inert gas forms a type of thermal barrier that shields the exit opening of the nozzle channel from the high-temperature gas and thus prevents a silicon-containing starting material entering the reaction space being decomposed or melted directly at the exit. Instead, the decomposition and/or melting of the silicon-containing starting material can occur at a distance from the exit opening.

As an inert gas, preference is given to using a gas that, under the conditions prevailing in the reaction space, reacts to a relative extent neither with the silicon-containing starting material nor with the silicon formed. The same gases as are heated in the device for producing the high-temperature gas, i.e., in particular, hydrogen, noble gases such as argon and mixtures thereof, are fundamentally suitable.

Particular preference is given to using the same gas, in particular hydrogen or a hydrogen/argon mixture, as inert gas and as high-temperature gas.

The inert gas is preferably at room temperature on introduction into the reaction space. In some examples, however, the inert gas can have its temperature modified, for example, be preheated so that the temperature difference between it and the high-temperature gas is not too great. The use of a cooled inert gas is also possible to improve thermal shielding.

Preferably, the apparatus is characterized by at least one of a. to c. immediately below:

a. the nozzle is a multifluid nozzle having a nozzle channel for feeding in the silicon-containing starting material as first nozzle channel,
b. the multifluid nozzle comprises a second nozzle channel that opens directly into the reaction space as the device for introducing the inert gas, and
c. the second nozzle channel opens into an exit opening that surrounds the exit opening of the first nozzle channel.

a. to c. immediately above are particularly preferably realized in combination with one another. In this way, the thermal shielding of the exit opening can be realized particularly elegantly.

Particular preference is given to the exit opening of the first nozzle channel being round, in particular circular, while the exit opening of the second nozzle channel has an annular shape. An inert gas introduced through this opening into the reaction space forms an annular inert gas stream that surrounds the silicon-containing starting material flowing into the reaction space.

Further preferably, the apparatus is characterized by at least one of a. to c. immediately below:

a. the apparatus comprises the nozzle for feeding in the silicon-containing starting material as first nozzle,
b. the apparatus comprises at least one second nozzle that opens directly into the reaction space, as device for introducing the inert gas, and
c. the at least one second nozzle is configured and/or arranged such that it produces an inert gas stream in the reaction space, which stream surrounds the exit opening of the nozzle channel of the first nozzle, preferably in an annular manner.

a. to c. immediately above are particularly preferably realized in combination with one another. This example is an alternative to the multifluid nozzle described. The function of the second nozzle channel having the preferably annular exit opening is assumed here by the at least one second nozzle. Preferably, a plurality of nozzles can, for example, be arranged so that the exit openings thereof surround the exit opening of the first nozzle in an annular manner as the at least one second nozzle. These nozzles can likewise generate an altogether annular inert gas stream.

Further preferably, the apparatus is characterized by at least one of a. or b. immediately below:

a. the reaction space is cylindrical at least in one segment, optionally in its entirety, and
b. the feed conduit for the high-temperature gas opens tangentially into the reaction space in this segment.

a. and b. immediately above are particularly preferably realized in combination with one another.

The cylindrical segment preferably has a nonangular cross section, in particular a circular or elliptical cross section. The cylinder axis of the cylindrical segment and thus the cylindrical segment itself are particularly preferably oriented vertically.

Particularly preferably, the feed conduit for the high-temperature gas opens tangentially into the reaction space at the upper end of the vertically oriented cylindrical segment. If the high-temperature gas is introduced at high flow velocities through such a channel opening tangentially into the reaction space, the gas is made to rotate because of the tangential opening of the channel. This results in a circular swirling motion of the gas or mixing of the gas with the silicon-containing starting material fed in, silicon vapor formed and any decomposition products arising within the reaction space.

Further preferably, the apparatus is characterized by at least one of a. to c. immediately below:

a. the reaction space is cylindrical at least in one segment, optionally also in its entirety,
b. the cylindrical segment is bounded radially by a circumferential side wall and axially at one side by a circular or elliptical closure element, and
c. the nozzle channel of the nozzle for feeding in the silicon-containing starting material is conducted through the closure element and opens axially or with a deviation of not more than 45° from an axial orientation into the reaction space.

a. to c. immediately above are particularly preferably realized in combination with one another.

In this example, too, the cylindrical segment preferably has a nonangular cross section, in particular a circular or elliptical cross section.

Furthermore, preference is also given in this example to the cylinder axis of the cylindrical segment and thus the cylindrical segment itself being oriented vertically. This means that in the axial or essentially axial orientation of the nozzle channel of the nozzle for feeding in the silicon-containing starting material as per c. immediately above, the silicon-containing starting material is preferably fed from above, in particular vertically from above, through the closure element which in this example forms a cover of the reaction space into the reaction space. In this example, the conduit for the high-temperature gas preferably opens tangentially into the reaction space through the radially circumferential side wall.

Further preferably, the apparatus is characterized by at least one of a. or b. immediately below:

a. the nozzle channel of the nozzle for feeding in the silicon-containing starting material opens into the reaction space at a distance from the circumferential side wall, and
b. the distance of the exit opening of the nozzle channel from the circumferential side wall is at least 20%, particularly preferably at least 40%, of the smallest diameter of the reaction space in the cylindrical segment.

a. and b. immediately above are preferably realized in combination with one another.

The closure element bounding the cylindrical segment particularly preferably has a circular shape and the nozzle channel of the nozzle for feeding in the silicon-containing starting material opens into the reaction space at the center of the closure element so that the distance to the circumferential side wall is a maximum in all directions.

Apart from the contacting of the silicon-containing starting material with the high-temperature gas, the question of, in particular, the transition of the silicon vapors formed into the liquid phase plays a large role. Rapid condensation of the silicon vapors is important to avoid formation of dust-like silicon. The spacing of the exit opening of the nozzle channel from the circumferential side wall has been found to be advantageous in respect of avoiding silicon dust. Furthermore, the condensation of the silicon vapors can, in particular, be promoted by the abovementioned swirling motion.

In a first particularly preferred example, the apparatus is characterized by at least one of a. or b. immediately below:

a. the reaction space comprises a conical segment in which the diameter becomes smaller in the direction of gravity, and
b. the reaction space comprises the above-described cylindrical segment and the conical segment that directly adjoins the cylindrical segment.

a. and b. immediately above are preferably realized in combination with one another. When the cylindrical segment is oriented vertically, the conical segment preferably directly adjoins the lower end of the cylindrical segment.

However, it is also quite possible for the reaction space not to merely comprise the conical segment but to be entirely conical. The reaction space then preferably has an elliptical or circular cross section and also a point, with the diameter becoming smaller in the direction of the point. Radially, it is bound by an outer wall running to a point and axially on the side of the maximum area by the circular or elliptical closure element, as in a cylindrical configuration.

There is preferably an outlet through which condensed silicon can be discharged from the reaction space at the lowest point of the conical segment or of the conical reaction space, i.e., at its point.

In the conical segment or in the conical reaction space, silicon vapor formed can, as in a centrifugal separator, move downward in a swirling motion around the walls of the segment in the direction of gravity toward the outlet. According to our experience, the conical design of the segment likewise leads to improved condensation. Compared to examples in which the reaction space is essentially completely cylindrical, significant improvements were obtained in this respect.

Particularly preferably, the closure element adjoining the cylindrical segment has a circular shape and the nozzle channel of the nozzle for feeding in the silicon-containing starting material opens into the reaction space at the center of the closure element so that the distance to the circumferential side wall is a maximum in all directions. The nozzle channel of the nozzle for feeding in the silicon-containing starting material opens into the reaction space at a distance from the circumferential side wall in this example.

Further particularly preferably, the feed conduit for the high-temperature gas and the nozzle channel of the nozzle for feeding in the silicon-containing starting material are both conducted through the circular or elliptical closure element and open axially, in particular axially from above, into the reaction space. In this example, the feed conduit for the high-temperature gas preferably opens into the reaction space at the center of the closure element.

We surprisingly found that the condensation and thus the yield of condensed silicon can be improved further when the apparatus is characterized by at least one of a. or b. immediately below:

a. the reaction space comprises an outlet through which gaseous silicon can be discharged from the reaction space, and
b. the outlet opens directly or indirectly into at least two, preferably into from two to 12, particularly preferably into from three to ten, in particular into from four to eight, condensation chambers which are arranged parallel to one another and taper conically in the direction of gravity.

a. and b. immediately above are particularly preferably realized in combination with one another.

Instead of or in addition to the conical segment of the reaction spaces or instead of or in addition to the conical shape of the reaction space, a plurality of condensation chambers that operate essentially like centrifugal separators are thus provided in this example. The condensation chambers preferably have a smaller flow cross section compared to the conical segment of the reaction spaces or the conical reaction space so that higher gas velocities can be realized in the condensation chambers than in the conical segment.

The advantage of the condensation chambers arranged parallel to one another is that controlling the gas velocities can be realized independently of the total throughput. Thus, it is possible, for example, to connect additional condensation chambers in parallel and thus adapt the gas velocities to increase the total throughput.

A parallel arrangement of the condensation chambers means that the stream of the gaseous silicon is divided, preferably uniformly, over the condensation chambers and the sub-streams flow simultaneously and thus in parallel to one another into the condensation chambers.

The condensation chambers preferably have a circular or elliptical cross section, at least in a subregion, and are cylindrical in their subregion. This subregion is preferably adjoined by a subregion in which the condensation chambers display the abovementioned conical taper.

Preference is given to the gaseous silicon being introduced into each of the condensation chambers via a channel that opens tangentially into the condensation chambers, in particular into the cylindrical subregion of the condensation chambers.

The gas velocities in the condensation chambers are determined, in particular, by the cross-sectional area of the tangential inlet opening. The upper limit is the speed of sound since when this is attained, shockwaves and a greatly increased pressure drop occur. The smaller the diameter of the condensation chambers, the narrower are the curves around which the gas has to flow in the swirling motion. However, if the diameter becomes too small, the swirling motion breaks down and the gas flows in normal plug flow through the condensation chambers, despite the tangential inlet opening.

The inlet openings particularly preferably have a diameter of 5 to 25 mm, particularly preferably 7 to 10 mm.

The diameter of the condensation chambers in the cylindrical subregion is preferably 20 to 100 mm, preferably 30 to 40 mm.

In general, the condensation chambers each have an outlet for condensed liquid silicon at their lowest point (like the conical segment).

The precise number of condensation chambers depends, in particular, on the size of the apparatus. If the apparatus is, for example, designed to produce 20 kg of silicon/hour, from four to six condensation chambers have been found to be sufficient. At higher throughputs, for instance at 50 kg silicon/hour, the number of condensation chambers can be increased, for example, eight. As mentioned above, it is also possible to adapt the number of cyclones flexibly in a change in throughput.

A pressure slightly above atmospheric pressure, in particular 1013 mbar to 2000 mbar, preferably prevails in the reaction chamber.

In some examples, the reaction space can have a discharge conduit for excess high-temperature gas and any gaseous decomposition product and also for particulate silicon formed. For example, this discharge conduit can be conducted through the closure element that bounds the cylindrical segment axially on one side. However, since excess gas and gaseous decomposition products can also be discharged from the reaction space through the abovementioned outlet for discharge of gaseous and/or liquid silicon, such a discharge conduit is optional.

Particularly preferably, the apparatus is characterized by at least one of a. to c. immediately below:

a. the nozzle for feeding in the gaseous or particulate silicon-containing starting material including the nozzle channel is conducted through a wall of the reaction space, in particular through the closure element, into the reaction space,
b. the nozzle projects into the reaction space so that the exit opening of the nozzle channel opens into the reaction space at a distance from the wall, and
c. the device that makes it possible to introduce inert gas into the reaction space such that it protects the exit opening of the nozzle channel against thermal stress arising from the high-temperature gas is thermally insulated from the wall by an insulation element.

a. and b. immediately above are preferably realized in combination with one another. Particular preference is given to a. to c. being realized in combination with one another.

Preferably, the wall of the reaction space through which the nozzle is conducted is preferably formed by the above-described closure element, the nozzle is preferably the above-described multifluid nozzle and the device that introduces the inert gas into the reaction space is preferably the above-described second nozzle channel.

The spacing of the axial opening from the wall of the reaction space serves to avoid formation of solid silicon deposits around the nozzle. The inert gas introduced into the reaction space preferably has a temperature significantly below the melting point of silicon. As a consequence, the temperature of the wall through which the nozzle is conducted can, particularly in the immediate vicinity of the nozzle and of the second nozzle channel, cool to a temperature below the melting point of silicon. The cooled wall regions should if possible not contact the silicon-containing starting material or gaseous silicon. Furthermore, the insulation element should counter the cooling of the wall. The insulation element preferably consists of a graphite felt.

In practice, the nozzle projects at least 0.5 mm, preferably at least 1 cm, into the reaction space.

The reaction space in which the silicon-containing starting material is contacted with the high-temperature gas has to be heat-resistant to be able to withstand the thermal stresses arising from the high-temperature gas. For example, the reaction space can for this purpose be lined with heat-resistant material such as graphite or consist of such materials. In particular, the walls of the reaction space, in particular the abovementioned side wall and the abovementioned closure element, can consist at least partly or entirely of such materials. As an alternative or in addition, the reaction space can have thermal insulation which thermally shields it from its surroundings.

It is important that silicon formed does not solidify within the reaction space during operation. The walls of the reaction space are therefore preferably maintained at a temperature in the region of the melting point of silicon during operation so that solid silicon deposits cannot form. The walls of the reaction space are ideally coated with a thin, closed layer of silicon which, however, does not grow during operation. Separate cooling means and/or heating means can be assigned to the reaction space to ensure this.

The process of forming liquid silicon is preferably carried out in the reaction space described. It always comprises steps a. to c. immediately below:

a. bringing a gas into a high-temperature state in which it is at least partially present as plasma,
b. introduction of the high-temperature gas into the reaction space, and
c. feeding of a gaseous or particulate silicon-containing starting material into the reaction space via a nozzle having a nozzle channel which opens directly into the reaction space.

The process is in particular characterized by step d. immediately below:

d. introduction of an inert gas into the reaction space so that it protects the exit opening of the nozzle channel against thermal stress arising from the high-temperature gas.

Preferred examples of the process have been disclosed above in the description of the apparatus.

The liquid silicon obtained can be processed further directly. For example, it is possible to convert the liquid silicon obtained directly into a single crystal.

Further features, details and preferred aspects can be derived from the claims and the abstract, the wording of each of which is incorporated by reference into the description, the following description of preferred examples and with the aid of the drawings.

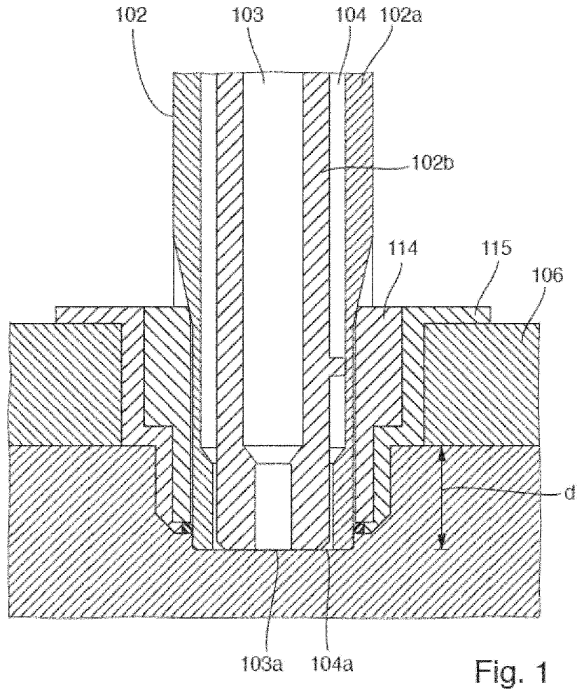

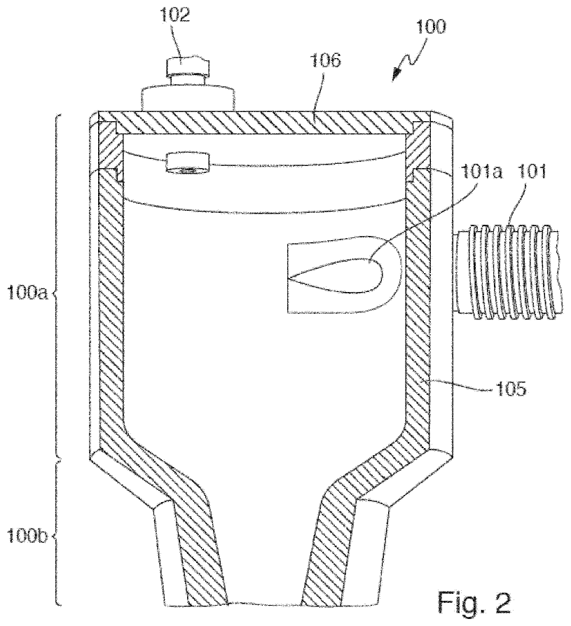

FIG. 1 depicts a multifluid nozzle 102 that feeds in the silicon-containing starting material, usually monosilane. The nozzle 102 is integrated into the closure element 106 of the reaction space 100 depicted in FIG. 2 so that the nozzle channel 103 of the nozzle 102, which feeds in the silicon-containing starting material, opens directly into the reaction space 100 (exit opening 103a) axially and at a distance from the side wall 105 of the reaction space 100. The nozzle is thermally insulated from the closure element 106 by the annular insulation element 114 which is enclosed by the graphite ring 115.

The nozzle 102 projects into the reaction space 100 so that the exit opening 103a of the nozzle channel 103 opens into the reaction space 100 at a distance from the closure element 106 (spacing d). This is intended to avoid formation of solid silicon deposits around the nozzle 102.

Apart from the nozzle channel 103, the multifluid nozzle 102 comprises the second nozzle channel 104. This too opens directly and axially into the reaction space 100 (exit opening 104a). The nozzle channels 103 and 104 are bounded by the concentrically arranged annular channel walls 102a and 102b.

During operation, an inert gas, usually hydrogen, is passed into the reaction space 100 through the opening 104a of the nozzle channel 104, which opening is configured as annular gap. This inert gas surrounds a monosilane stream injected through the nozzle channel 103 in an annular manner and shields the exit opening 103a of the nozzle channel 103 from thermal stresses within the reaction space 100.

The reaction chamber 100 into which the multifluid nozzle 102 depicted in FIG. 1 opens is depicted in FIG. 2. The reaction space 100 comprises the cylindrical segment 100a and the conical segment 100b which directly adjoins the cylindrical segment 100a. The cylindrical segment 100a and thus the reaction space 100 are oriented vertically. The cylindrical segment 100a is bounded radially by the circumferential side wall 105 and axially at the top by the circular closure element 106.

A gas that has been heated to a high temperature by a plasma generation device can be fed via the conduit 101 into the reaction space 100. The feed conduit 101 for the high-temperature gas opens tangentially into the reaction space 100 in the cylindrical segment 100a.

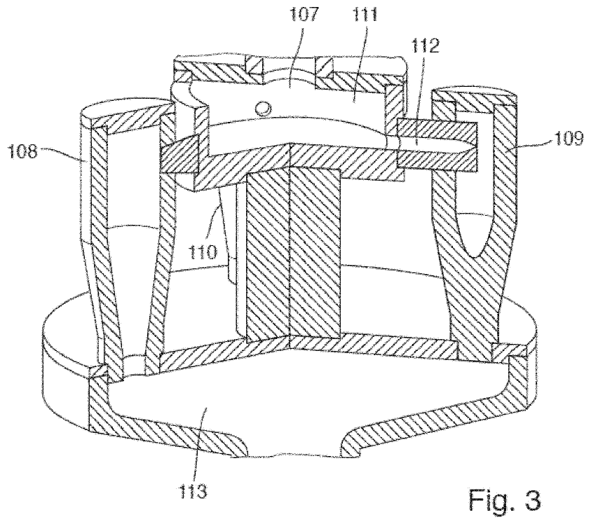

FIG. 3 depicts a plurality of condensation chambers 208, 109 and 110 for condensation of silicon. The reaction space 100 comprises an outlet 107 which is located at the lower end of the reaction space and through which gaseous silicon can be discharged together with previously condensed silicon from the reaction space 100. Via the distributor chamber 111, the gaseous silicon is transferred into the three condensation chambers 108, 109, 110 which taper conically in the direction of gravity. The three condensation chambers 108, 109, 110 all have a reduced cross section in the flow direction, which ensures a high flow velocity within the condensation chambers. Gaseous silicon can condense in the condensation chambers. The condensed silicon can flow out via the collection space 113.

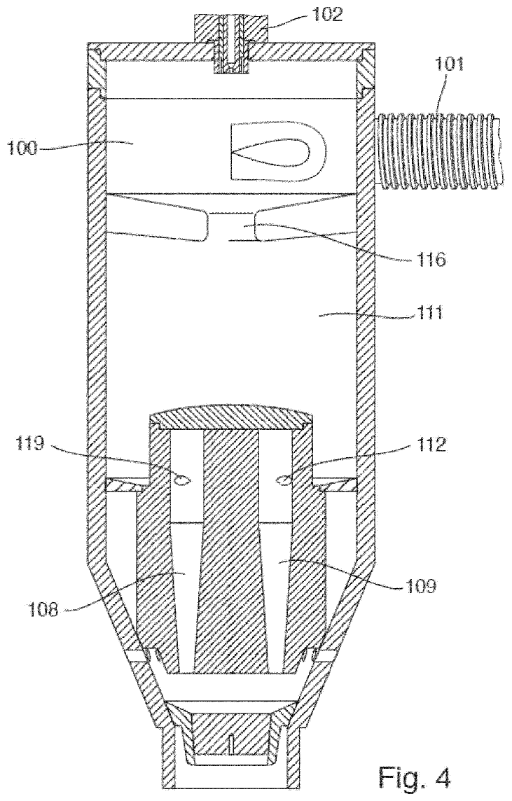

The apparatus depicted in FIG. 4 comprises the reaction space 100, the distributor chamber 111 and a plurality of condensation chambers 108, 109. Monosilane is fed via the multifluid nozzle 102 into the reaction space 100. The nozzle 102 is configured as shown in FIG. 1. Through the feed conduit 101, a gas which has been heated to a high temperature by a plasma generation device is fed into the reaction space 100. The feed conduit 101 for the high-temperature gas opens tangentially into the reaction space 100.

The reaction space 100 is in large parts cylindrical. Only at its lower end does it have a conical point which opens in the passage 116 which leads into the distributor chamber 111. Channels 112 and 119 lead from the lowest point of the distributor chamber into the condensation chambers 108, 109. The outlet for condensed silicon is not visible in the section depicted.

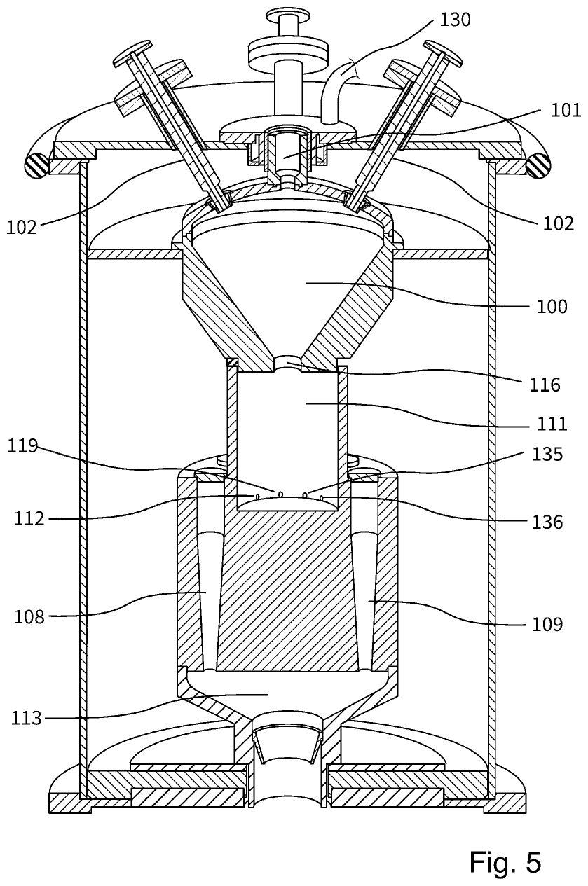

The apparatus depicted in FIG. 5 comprises the reaction space 100, the distributor chamber 111 and a plurality of condensation chambers 108, 109, 110 and 117. Monosilane can be fed into the reaction space 100 via two multifluid nozzles 102. The nozzles 102 do not necessarily have to be operated simultaneously. This can be varied as a function of the desired throughput. Gas that has been heated to a high temperature by a plasma generation device is fed through the feed conduit 101 into the reaction space 100. The feed conduit 130 moderates the temperature of the high-temperature gas. The high-temperature gas can thus be admixed with a moderation gas before it is fed into the reaction space.

The feed conduit 101 for the high-temperature gas opens axially and centrally into the reaction space 100. The nozzles 102, on the other hand, are arranged offset and at an angle to the feed conduit 101, but at a distance from the side walls of the reaction space. As a result, a monosilane stream or monosilane-containing stream fed in by the nozzles 102 impinges at an angle of 15-35° onto the stream of the high-temperature gas.

The reaction space 100 has a conical configuration. At its lower end, it opens into the passage 116 which leads into the distributor chamber 111. Silicon formed in the reaction space 100 can be discharged through the passage 116.

From the lowest point of the distributor chamber 111, channels 112, 119, 135 and 136 lead into the condensation chambers 108, 109, 110 and 117. The apparatus depicted has a total of nine condensation chambers which are configured as centrifugal separators and are arranged in a circle around the distributor chamber 111. The plurality of condensation chambers is not visible in the section depicted. The silicon which has been condensed in the condensation chambers can flow out via the collection space 113.

1-10. (canceled)

11. An apparatus that forms liquid silicon comprising:
a. a device by which a gas can be brought to a high-temperature state in which it is at least partially present as plasma,
b. a reaction space and a feed conduit for the high-temperature gas opening into the reaction space,
c. a nozzle having a nozzle channel that opens directly into the reaction space and through which a gaseous or particulate silicon-containing starting material can be fed into the reaction space, and
d. a device adapted to introduce an inert gas into the reaction space such that it protects the exit opening of the nozzle channel against thermal stress resulting from the high-temperature gas.

12. The apparatus as claimed in claim 11, wherein
a. the nozzle is a multifluid nozzle having a nozzle channel that feeds in the silicon-containing starting material as first nozzle channel,
b. the multifluid nozzle comprises a second nozzle channel that opens directly into the reaction space as the device that introduces the inert gas, and
c. the second nozzle channel opens into an exit opening that surrounds the exit opening of the first nozzle channel.

13. The apparatus as claimed in claim 11, wherein
a. the nozzle that feeds in the silicon-containing starting material is a first nozzle,
b. at least one second nozzle opens directly into the reaction space is the device that introduced the inert gas, and
c. the at least one second nozzle is configured and/or arranged such that it produces an inert gas stream in the reaction space, which stream surrounds the exit opening of the nozzle channel of the first nozzle.

14. The apparatus as claimed in claim 11, wherein
a. the reaction space is cylindrical at least in one segment or in its entirety, and
b. the feed conduit for the high-temperature gas opens tangentially into the reaction space in this segment.

15. The apparatus as claimed in claim 11, wherein
a. the reaction space is cylindrical at least in one segment or in its entirety,
b. the cylindrical segment is bounded radially by a circumferential side wall and axially at one side by a circular or elliptical closure element, and
c. the nozzle channel of the nozzle that feeds in the silicon-containing starting material is conducted through the closure element and opens axially or with a deviation of not more than 45° from an axial orientation into the reaction space.

16. The apparatus as claimed in claim 15, wherein at least one of:
a. the nozzle channel of the nozzle that feeds in the silicon-containing starting material opens into the reaction space at a distance from the circumferential side wall, and
b. a distance of the exit opening of the nozzle channel from the circumferential side wall is at least 20% of the smallest diameter of the reaction space in the cylindrical segment.

17. The apparatus as claimed in claim 14, wherein
a. the reaction space comprises a conical segment in which the diameter becomes smaller in the direction of gravity, and
b. the reaction space comprises the cylindrical segment and the conical segment that directly adjoins the cylindrical segment.

18. The apparatus as claimed in claim 11, wherein
a. the reaction space comprises an outlet through which gaseous silicon can be discharged from the reaction space, and
b. the outlet opens directly or indirectly into at least two condensation chambers arranged parallel to one another and taper conically in a direction of gravity.

19. The apparatus as claimed in claim 11, wherein
a. the nozzle including the nozzle channel is conducted through a wall of the reaction space or the closure element and into the reaction space,
b. the nozzle projects into the reaction space so that the exit opening of the nozzle channel opens into the reaction space at a distance from the wall through which the nozzle is conducted into the reaction space, and
c. the device is thermally insulated from the wall by an insulation element.

20. A process of forming liquid silicon, comprising:
a. bringing a gas into a high-temperature state in which it is at least partially present as plasma,
b. introducing the high-temperature gas into the reaction space,
c. feeding a gaseous or particulate silicon-containing starting material into the reaction space via a nozzle having a nozzle channel that opens directly into the reaction space, and
d. introducing an inert gas into the reaction space so that it protects the exit opening of the nozzle channel against thermal stress arising from the high-temperature gas.
